(19) United States
(12) Patent Application Publication
(10) Pub. No.: US 2024/0394529 A1
(43) Pub. Date: Nov. 28, 2024

(54) GENERATIVE MACHINE LEARNING BASED PETROPHYSICS INTERPRETATION

(71) Applicant: Halliburton Energy Services, Inc., Houston, TX (US)

(72) Inventors: Huiwen SHENG, Singapore (SG); Xusong WANG, Singapore (SG)

(73) Assignee: Halliburton Energy Services, Inc., Houston, TX (US)

(21) Appl. No.: 18/386,469

(22) Filed: Nov. 2, 2023

Related U.S. Application Data
(60) Provisional application No. 63/469,314, filed on May 26, 2023.

(51) Int. Cl. G06N 3/08; G06N 3/0475

(52) U.S. Cl. CPC G06N 3/08; G06N 3/0475

(57) ABSTRACT

Aspects of the disclosed technology provide solutions for analyzing and interpreting geophysical and petrophysical data and in particular, for using generative machine learning models to characterize and predict reservoir properties. A process of the disclosed technology can include steps for providing a set of formation measurement data to a generative machine learning model and generating, via the generative machine learning model, a set of latent space data corresponding to the set of formation measurement data. The process can further include steps for clustering the set of latent space data to generate a set of clusters and determining a petrophysical interpretation based on the clusters. Systems and machine-readable media are also provided.

### INTRODUCTION

### 1. Related Application

This application claims the benefit of U.S. Provisional Application No. 63/469,314, entitled “GENERATIVE MACHINE LEARNING BASED PETROPHYSICS INTERPRETATION,” filed May 26, 2023, which is hereby incorporated by reference in its entirety.

### BACKGROUND

### 2. Technical Field

The present disclosure generally relates to solutions for analyzing and interpreting geophysical and petrophysical data and, in particular, for using generative machine learning models to characterize and predict formation and/or reservoir properties.

### 3. Introduction

Petrophysics interpretation is the process of analyzing and interpreting geophysical and petrophysical measurement data to characterize and predict reservoir or formation properties. The data used to perform petrophysics interpretations can include, but are not limited to, well logs (e.g., measurements of physical properties of the rocks and fluids in the subsurface), core samples, production data, seismic data, and from other data sources.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1A is a schematic diagram of an example wireline logging environment, according to some aspects of the disclosed technology.

FIG. 1B is a schematic diagram of an example logging environment of FIG. 1A, according to some aspects of the disclosed technology.

FIG. 2 illustrates a conceptual system diagram for generating petrophysical interpretations using a generative machine learning (ML) model, according to some aspects of the disclosed technology.

FIG. 3 illustrates an example system, that includes a Variational Autoencoder (VAE) ML model, according to some aspects of the disclosed technology.

FIG. 4 illustrates a visualization for clustering latent space data, according to some aspects of the disclosed technology.

FIG. 5 illustrates an example workflow that can be used to perform latent space clustering using a VAE, according to some aspects of the disclosed technology.

FIG. 6 illustrates an example workflow for using a generative machine learning model to perform latent space clustering, according to some aspects of the disclosed technology.

FIG. 7 illustrates an example workflow to perform latent space clustering using a VAE and a generative machine learning model, according to some aspects of the disclosed technology.

FIG. 8 illustrates an example system of a generative adversarial network (GAN), according to some aspects of the disclosed technology.

FIG. 9 illustrates a system diagram utilizing GANs to perform lithographic classification, according to some aspects of the disclosed technology.

FIG. 10 illustrates an example workflow for implementing a generative model with an uncertain number of inputs, according to some aspects of the disclosed technology.

FIG. 11 illustrated an example of a process for using a generative machine learning model to output a petrophysical interpretation, according to some aspects of the disclosed technology.

FIG. 12 illustrates an example of a machine learning architecture, according to some aspects of the disclosed technology.

FIG. 13 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring certain concepts.

Data needed to perform petrophysics interpretations can include raw well log data, including measurements such as electrical resistivities, acoustic velocities, and nuclear magnetic resonance (NMR) transverse-relaxation-time (T2) distributions. Other data sources, such as seismic data and core samples, may also be used as input. The output of a petrophysics interpretation can be a set of interpreted values of reservoir properties such as porosity, permeability, and fluid saturation, as well as other geological features such as lithology and structural elements.

Challenges can arise in performing petrophysics interpretations due to the complexity and heterogeneity of subsurface geological formations. Interpreting well log data can require significant expertise and experience in petrophysics and geology, as well as an understanding of the specific characteristics of the reservoir being analyzed. As such, the interpretation process can be time-consuming and may be subject to errors due to the subjectivity of the interpretation and the inherent uncertainty in subsurface data.

Furthermore, traditional petrophysics interpretation may involve a manual process of picking and analyzing individual well log curves, which can be tedious and prone to errors. It also may require human experts to make subjective decisions about which interpretation methods and parameters to use, which can lead to variability in the results.

In summary, petrophysics interpretation may be a critical step in characterizing and predicting the properties of subsurface geological formations. However, the complexity and heterogeneity of the data can make the process challenging and time-consuming, and traditional interpretation methods can be subject to errors and variability.

Aspects of the disclosed technology address the foregoing needs by providing machine-learning solutions for facilitating the petrophysical interpretation process in various application scenarios, including, but not limited to, lithological interpretation, reservoir characterization, geomechanical interpretation, and petrophysics and geophysics joint interpretation.

In some examples, petrophysics interpretation can be facilitated using generative machine learning that involves training a model to generate petrophysical interpretations of geophysical and petrophysical data. This approach can be used to automate the interpretation of petrophysical data, which may improve the efficiency and accuracy of the interpretation process in the oil and gas industry.

Generative machine learning models, including, but not limited to, generative adversarial networks (GANs), variational autoencoders (VAEs), flow-based generative models (FBGMs), Naive Bayes classifiers, Gaussian Mixture Models (GMMs), Hidden Markov Models (HMIs), and Restricted Boltzmann Machines (RBMs) can be trained on large datasets of petrophysical data (or measurement data or formation measurement data), such as well logs, seismic data, and core samples. In some cases, these models can learn the underlying patterns and relationships in the measurement data and can generate new interpretations based on this knowledge.

The generated petrophysical interpretations can be used to predict properties of the reservoir, such as rock types, fluid types, porosity, permeability, formation pressure, and saturation, which may be essential for reservoir characterization and production forecasting. In some cases, this approach can also be used to identify anomalies or patterns in the data that may not be immediately apparent to human experts.

In some examples, one advantage of generative machine learning based petrophysics interpretation is that it can help to reduce the time and cost of manual interpretation of petrophysical data, which can be time-consuming and may require significant expertise. Generative machine learning based petrophysics interpretation may also have the potential to improve the accuracy and consistency of the interpretation, as it may incorporate a large amount of data and learn the underlying patterns in a way that may be difficult for humans.

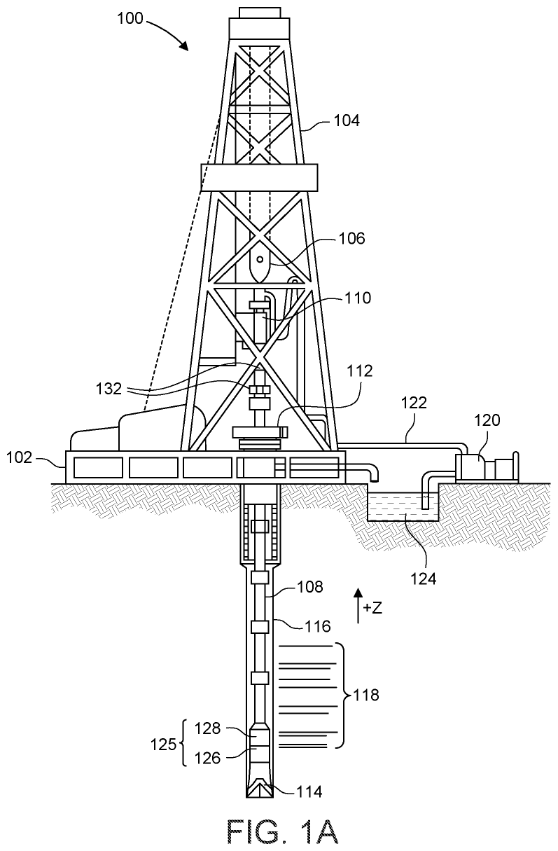

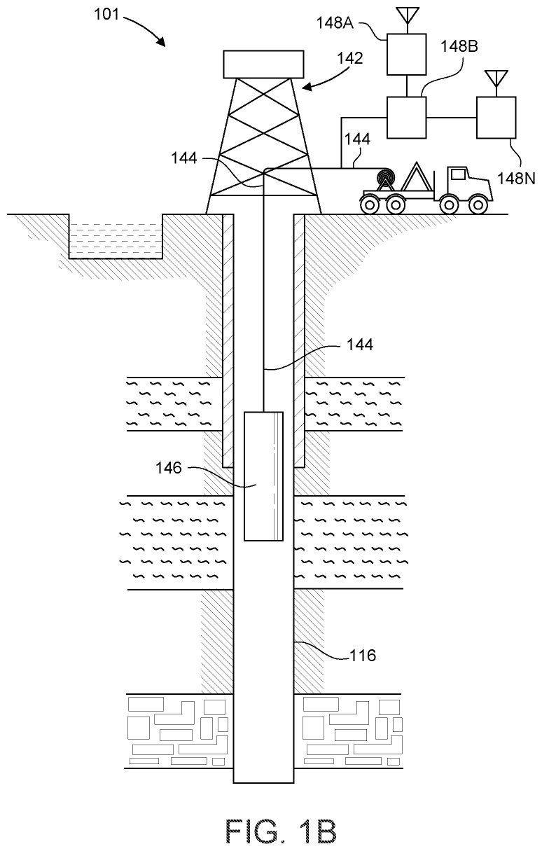

The disclosure now turns to FIGS. 1A-B to provide a brief introductory description of the larger systems that can be employed to practice the concepts, methods, and techniques disclosed herein. A more detailed description of the methods and systems for implementing the improved semblance processing techniques of the disclosed technology will then follow.

FIG. 1A is a schematic diagram of an example wireline logging environment 100, in accordance with various aspects of the subject technology. As shown, in this example, a drilling platform 102 supports a derrick 104 that has a traveling block 106 for raising and a lowering drill string 108. A kelly 110 supports the drill string 108 as it is lowered through a rotary cable 112. A drill bit 114 is driven by a downhole motor and/or rotation of the drill string 108. As a drill bit 114 of the drill string 108 rotates, it drills a borehole 116 that passes through one or more formations 118. A pump 120 circulates drilling fluid through a feed pipe 122 to the kelly 110 downhole through the interior of the drill string 108 and orifices in the drill bit 114, back to the surface via the annulus around the drill string 108 and into a retention pit 124. The drilling fluid transports cuttings from the borehole into pit 124 and aids in maintaining borehole integrity.

A downhole tool 126 can take the form of a drill collar (e.g., a thick-walled tubular that provides weight and rigidity to aid the drilling process) or any other known and/or suitable arrangement. Further, the downhole tool 126 can include one or more logging tools such as, for example and without limitation, one or more acoustic (e.g., sonic, ultrasonic, etc.) logging tools and/or one or more other types of logging tools and/or corresponding components. The downhole tool 126 can be integrated into a bottom-hole assembly 125 near the drill bit 114. As the drill bit 114 extends the borehole through formations, the bottom-hole assembly 125 can collect logging data and/or sensor data (e.g., NMR data and/or any other logging and/or sensor data). The downhole tool 126 can include transmitters (e.g., monopole, dipole, quadrupole, etc.) to generate and transmit signals/waves into the borehole environment such as, for example and without limitation, acoustic signals/waves, radio frequency (RF) signals/waves, optical signals/waves, and/or any other signals/ways. These signals/waves propagate in and along the borehole and the surrounding formation(s) and create signal responses or waveforms, which are received/recorded by one or more receivers.

For purposes of communication, a downhole telemetry sub 128 can be included in the bottom-hole assembly 125 to transfer measurement data to a surface receiver 132 and receive commands from the surface (e.g., from a device at the surface such as a computer and/or a transmitter). Mud pulse telemetry is one example telemetry technique for transferring tool measurements to surface receivers and receiving commands from the surface. However, other telemetry techniques can also be used. Other, non-limiting example telemetry techniques that can be implemented can include fiber optic telemetry, electric telemetry, acoustic telemetry through the pipe, and electromagnetic (EM) telemetry, among others. In some aspects, the telemetry sub 128 can store logging data for later retrieval at the surface when the logging assembly is recovered.

At the surface, the surface receiver 132 can receive the uplink signal from the downhole telemetry sub 128. The surface receiver 132 can include, for example and without limitation, a wireless receiver, a computer (e.g., a laptop computer, a desktop computer, a tablet computer, a server computer, and/or any other type of computer), and/or any other device with data communication capabilities (e.g., wired and/or wireless). In some cases, the surface receiver 132 can communicate the signal from the downhole telemetry sub 128 to a data acquisition system (not shown). Such a data acquisition system can be part of the surface receiver 132 or can be a separate device such as, for example, a computer, a storage device, etc. The surface receiver 132 can include one or more processors, storage devices, input devices, output devices, memory devices, software, and/or the like. The surface receiver 132 can collect, store, and/or process the data received from tool 126 as described herein.

In some examples, the surface receiver 132 can include a single receiver or multiple receivers. In some cases, the surface receiver 132 can include a set of evenly spaced receivers or a set of receivers in any other arrangement. The surface receiver 132 can include a number of receivers arranged in an array and/or evenly spaced (or spaced in any other configuration/arrangement) apart to facilitate capturing and processing response signals at specific intervals. The response signals/waves can be analyzed to determine borehole and adjacent formation properties and/or characteristics. Depending on the implementation, other logging tools may be deployed. For example, logging tools configured to measure electric, nuclear, gamma and/or magnetism levels may be used. Logging tools can also be implemented to measure other properties, events, and/or conditions such as, for example and without limitation, pressure, measure fluid viscosity, measure temperature, perform fluid identification, measure a tool orientation, and/or obtain any other measurements.

At various times during the process of drilling a well, the drill string 108 may be removed from the borehole 116 as shown in example environment 101, illustrated in FIG. 1B. Once the drill string 108 has been removed, logging operations can be conducted using the downhole tool 126 (e.g., a logging tool, a sensing instrument sonde, etc.) suspended by a conveyance (e.g., conveyance 144 shown in FIG. 1B). In one or more examples, the conveyance can be or include a cable having conductors for transporting power to the tool and telemetry from the tool to the surface. In some examples, the downhole tool 126 can have pads and/or centralizing springs to maintain the tool near the central axis of the borehole or to bias the tool towards the borehole wall as the tool is moved downhole or uphole.

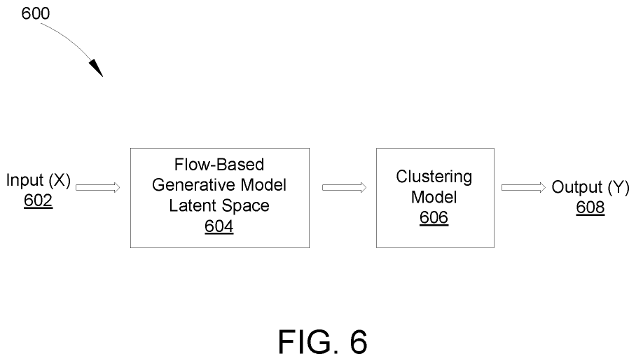

In some examples, the downhole tool 126 can include an acoustic or sonic logging instrument that collects acoustic logging data within the borehole 116. As mentioned above, other logging instruments may additionally or alternatively be used. A logging facility can include a computer system, such as the computer system 600 described with reference to FIG. 6, for collecting, storing, and/or processing the data/measurements gathered by the downhole tool 126. For example, the logging facility may include a logging data management system for modifying NMR logging data to be compatible with a temperature correction algorithm determined based on laboratory generated NMR data and applying the temperature correction algorithm to the modified logging data, if needed.

In one or more examples, a conveyance of the downhole tool 126 may include at least one of wires, conductive and/or non-conductive cable (e.g., slickline, etc.), and/or tubular conveyances such as coiled tubing, pipe string, or downhole tractor. In some cases, the downhole tool 126 can have a local power supply, such as batteries, a downhole generator, and/or the like. When employing a non-conductive cable, coiled tubing, pipe string, or a downhole tractor, communication can be supported using, for example, wireless protocols (e.g., EM, acoustic, etc.), and/or measurements and logging data may be stored in local memory for subsequent retrieval. In some aspects, electric or optical telemetry is provided using conductive cables and/or fiber optic signal-paths.

Referring to FIG. 1B, a tool having tool body 146 can be employed with “wireline” systems, in order to carry out logging or other operations. For example, instead of using the drill string 108 of FIG. 1A to lower tool body 146, which may contain sensors or other instrumentation for detecting and logging nearby characteristics and conditions of the wellbore and surrounding formation, the tool body 146 can be lowered by a wireline conveyance 144. Thus, as shown in FIG. 1B, the tool body 146 can be lowered into the wellbore 116 by the wireline conveyance 144. The wireline conveyance 144 can be anchored in a drill rig 142 or portable means such as a truck. The wireline conveyance 144 can include one or more wires, slicklines, cables, and/or the like, as well as tubular conveyances such as coiled tubing, joint tubing, or other tubulars.

The illustrated wireline conveyance 144 can provide support for the tool (e.g., tool body 146), enable communication between the tool processors on the surface, and/or provide a power supply. The wireline conveyance 144 can include fiber optic cabling for carrying out communications. The wireline conveyance 144 can be sufficiently strong and flexible to tether the tool body 146 through the wellbore 116, while also permitting communication through the wireline conveyance 144 to one or more local processors 148B and/or one or more remote processors 148A, 148N. Power can be supplied via wireline conveyance 144 to meet power requirements of the tool. For slickline or coiled tubing configurations, power can be supplied downhole with a battery or via a downhole generator, for example.

Although FIGS. 1A and 1B depict specific borehole configurations, it is understood that the present disclosure is suited for use in wellbores having other orientations including vertical wellbores, horizontal wellbores, slanted wellbores, multilateral wellbores, and the like. While FIGS. 1A and 1B depict an onshore operation, it should also be understood that the present disclosure is suited for use in offshore operations. Moreover, the present disclosure is not limited to the environments depicted in FIGS. 1A and 1B and can also be used in other well operations such as, for example and without limitation, production tubing operations, jointed tubing operations, coiled tubing operations, combinations thereof, and/or the like.

It is also understood that the wellbores discussed and production from such wellbores which may be an ultimate outcome of the present disclosure, may, in addition to wells for production of hydrocarbons, also include wells for production of geothermal energy, and wells for injection or sequestration or storage of materials (e.g. steam, waste material, CO2, or hydrogen), for which the well construction and completion processes are similar to those for hydrocarbons, and the implementations herein also apply.

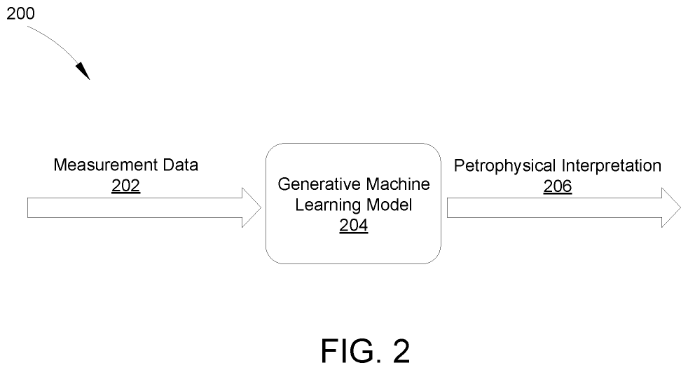

FIG. 2 illustrates a conceptual system diagram 200 for generating petrophysical interpretations 206 using a generative machine learning model 204, according to some aspects of the disclosed technology. A petrophysical interpretation 206 can include analyzing physical and chemical properties of rocks and the fluids they contain, usually from well log data (e.g., as illustrated by measurement data 202 in FIG. 2).

The input or measurement data (or measurements) 202 to generative machine learning model 204 may include well log data which can include a detailed record of the geological formations penetrated by a borehole. Examples of well log data may include, but are not limited to, resistivity logs, gamma ray logs, porosity logs, sonic/acoustic logs, NMR logs, and/or formation pressure logs, etc. Measurement data 202 may also include other data types such as core samples, seismic data, production rages, fluid flow, pressure data, and geological information. Those skilled in the art will appreciate additional types of measurement data 202 that can be inputted into generative machine learning model 204, without departing from the scope of the disclosed technology.

By way of example, petrophysical interpretation 206 data may include data corresponding to properties and/or characteristics associated with subsurface rock formations such as rock types, porosity, permeability, saturation, lithology, formation pressure, and fluid types. Those skilled in the art will appreciate additional properties and/or characteristics corresponding to petrophysical interpretation 206 data.

As discussed above, generative machine learning model 204 types may include, but are not limited to, GANs, VAEs, FBGMs, Naive Bayes classifiers, GMMs, HMMs, and RBMs. Those skilled in the art will appreciate additional types of generative machine learning models 204.

The use of a generative machine learning model 204 may enable fast, accurate, and consistent interpretation of large scale petrophysical data that may not be feasible using conventional approaches. For example, generative machine learning model 204 may use measurement data 202 for data augmentation and generate new data samples by learning underlying patterns and relationships in the data. In another example, generative machine learning model 204 can be trained on available data and then be used to generate additional synthetic data (e.g., well log data) that can mimic real-world scenarios. In addition, generative machine learning model 204 may fill in data gaps based on learned patterns from training data. The generative machine learning model 204 may also simulate different subsurface properties that may change under various conditions.

The petrophysical interpretation 206 can depend on the type of measurement data 202 provided to the generative machine learning model. For example, four application scenarios may include a lithological interpretation, reservoir characterization, geomechanical interpretation, and a petrophysics and geophysics based joint interpretation.

In a lithological interpretation, inputs (e.g., measurement data 202) may include physical properties of the rocks in the subsurface, such as gamma ray logging and spontaneous potential logging data. The output, (e.g., petrophysical interpretation 206), may include descriptions of different types of rocks present in the formation which can be classified according to lithology such as mineral composition, grain size, and texture, etc.

In a reservoir characterization, measurement data 202 may include well logs, core samples, seismic data, production rates, fluid flow, and pressure data. The corresponding petrophysical interpretation 206 may include:
(1) Geological features (e.g., structural features such as faults, folds, and fractures, as well as stratigraphic features such as lithology, porosity, permeability, and thickness).
(2) Petrophysical properties (e.g., properties of the rocks such as porosity, permeability, and fluid saturation, which may be critical for estimating the reservoir's ability to store and transmit fluids).
(3) Fluid properties (e.g., properties of the fluids such as viscosity, density, and composition, which may be critical for predicting fluid flow behavior in the reservoir).
(4) Three-dimensional (3D) models and maps (e.g., a visual representation of the subsurface reservoir, including the distribution of geological features, petrophysical properties, and fluid properties).
(5) Production forecasts (e.g., estimates of the expected production rates and volumes from the reservoir under different production scenarios).
(7) Risk assessments (e.g., evaluations of the uncertainties and risks associated with the reservoir, such as the likelihood of encountering unexpected geological features or variations in fluid properties).
(8) Recommendations (e.g., suggested courses of action based on the results of the reservoir characterization, such as where to drill new wells, how to optimize production from existing wells, and how to manage the reservoir over time).

In a geomechanical interpretation, measurement data 202 may include well logs, core samples, seismic data, and geological information. The corresponding petrophysical interpretation 206 may include:
(1) Maps and cross-sections of the geomechanical properties of the rocks.
(2) Quantitative estimates of the mechanical properties of the rocks, such as rock strength, elasticity, and ductility.
(3) Identification of potential areas of subsurface instability, such as areas with high risk of rock failure, fault reactivation, or formation damage.
(4) Recommendations for mitigating the risks of subsurface instability, such as modifications to drilling and completion practices, or changes to the overall development plan.

In a petrophysics and geophysics interpretation, measurement data 202 may include well logs, core samples, seismic data, and geological information. The corresponding petrophysical interpretation 206 may include:
(1) 3D models and maps of the subsurface geology and reservoir properties, which can be used to guide drilling and development decisions.
(2) Quantitative estimates of the petrophysical properties of the rock formations, such as porosity, permeability, and fluid saturation, which can be used to estimate the reservoir's ability to store and transmit fluids.
(3) Identification of subsurface structures, such as faults and fractures, which can impact reservoir behavior.
(4) Recommendations for optimizing production, such as recommendations for where to drill new wells, or how to optimize production from existing wells.

The four application scenarios discussed above may use various combinations of generative machine learning models 204 (e.g., GANs, VAEs, FBGMs, Naive Bayes classifiers, GMMs, HMMs, RBMs) applicable to each respective scenario.

A VAE may need to be trained to learn a compact and structured representation of input data (e.g., measurement data 202) in its latent space. During training, a VAE learns to encode input data into this latent space and then decode it back to its original form.

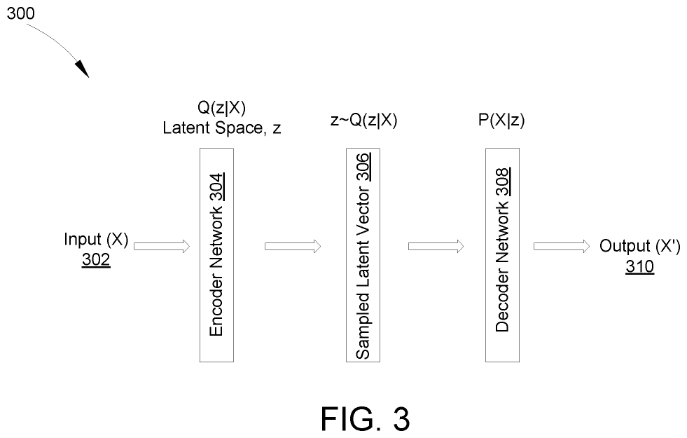

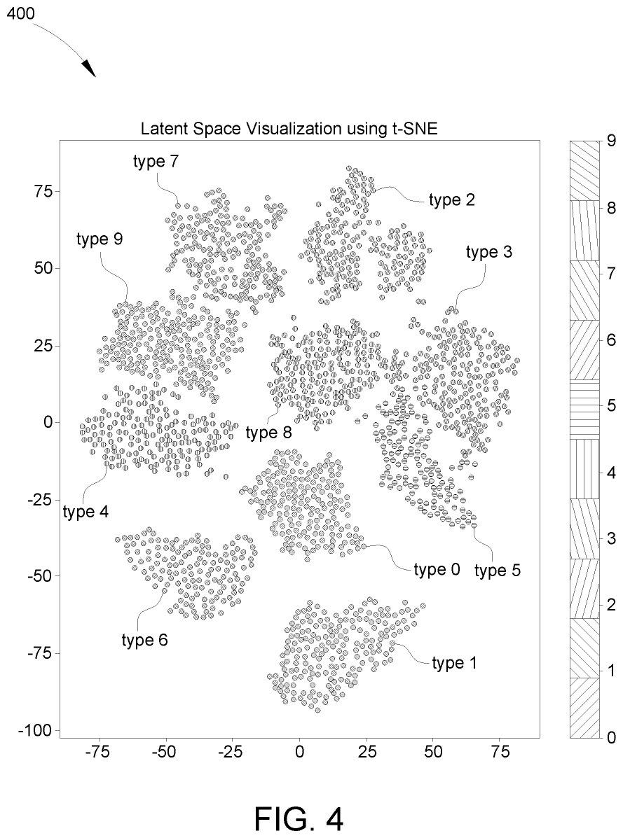

FIG. 3 illustrates an example system 300, that includes a Variational Autoencoder (VAE), according to some aspects of the disclosed technology. In some aspects, system 300 can be used to perform training of a VAE. By way of example, VAE can receive training measurement data as input X 302 (e.g., well logs, core samples, seismic data) and pass it through encoder 304, which can translate input X 302 into a distribution over the latent space, z (e.g., Q(z|X) as illustrated in FIG. 3). In some cases, after training a VAE, the latent space data can be labeled and/or distributed in groups (e.g., in clusters) which will be discussed in FIG. 4 below.

In a VAE, rather than producing one fixed vector for each input X 302, encoder 304 can output parameters that define a probability distribution of possible latent vectors. For example, representing data in the latent space as distributions may allow for variability and uncertainty in the latent space. Next, the sampled latent vector 306 (e.g., z is sampled from Q(z|X) denoted as z˜Q(z|X)) may be randomly drawn or sampled from the distribution of possible latent vectors. In other words, feeding the same input X 302 into a VAE multiple times may result in a different sampled latent vector, z 306 each time.

The sampled latent vector 306 may then be transmitted to decoder network 308 which can attempt to reconstruct input X 302 based on the sampled latent vector 306 (e.g., z˜Q(z|X)) and produce Output X′ 310. P(X|z) can represent the probability distribution of reconstructing the original input X 302 data given a particular sampled latent vector, z 306. In other words, given a sampled latent vector 306, there may be multiple reconstructions of input X 302, and P(X|z) can provide the probability of each potential reconstruction.

After the encoder 304, latent space, and decoder 308 are well constructed (e.g., after training), clustering and labeling can be performed on the vectors in the latent space, as illustrated in FIG. 4.

FIG. 4 illustrates a visualization 400 for clustering latent space data, according to some aspects of the disclosed technology. After the encoder, latent space, and decoder as discussed above in FIG. 3 are well constructed or well trained, clustering algorithms may be applied to the latent space, z to group similar points into distinct clusters. As illustrated in FIG. 4, similar rock types or properties can be clustered together as designated by types 1 through 9 (e.g., limestone, sandstone, shale, etc.).

Example clustering algorithms that may be applied to the latent space data may include, but are not limited to, K-means clustering, Density-Based Spatial Clustering of Applications with Noise (DBSCAN), hierarchical clustering, gaussian mixture model (GMM) clustering, spectral clustering, mean shift clustering, Ordering Points To Identify the Clustering Structure (OPTICS), and Balanced Iterative Reducing and Clustering using Hierarchies (BIRCH). Those skilled in the art will appreciate additional examples of clustering algorithms that may be applied to the latent space of a generative machine learning model.

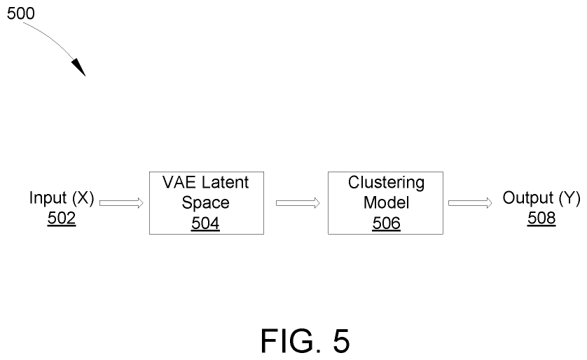

FIG. 5 illustrates an example workflow 500 that can be used to perform latent space clustering using a VAE, according to some aspects of the disclosed technology. By way of example, consider a lithological interpretation, where input X 502 represents raw measurement data acquired from subsurface rocks, such as readings from gamma ray logging and spontaneous potential logging. For example, these measurements may provide insights into the physical properties of the subsurface formations.

The Variational Autoencoder (VAE) may process input X 502 data and compress it into a lower-dimensional VAE latent space 504. For example, VAE latent space 504 may include features of input X 502 data in a more compact form. In the context of lithological interpretation, the VAE may be trained to capture the most relevant features of different rock types from input X 502 measurements.

Once the data is transformed into the VAE latent space 504, clustering model 506 may apply clustering algorithms to group similar data points together. These clusters can represent distinct rock types or lithologies. By analyzing patterns and similarities in VAE latent space 504, clustering model 506 can identify which measurements likely belong to the same rock type.

After clustering, each cluster can be associated with a specific rock type or lithological description as shown by output Y 508. For example, one cluster may be identified as limestone based on its gamma ray and spontaneous potential readings. This step can translate the clusters in VAE latent space 504 into meaningful lithological descriptions and can provide a clear interpretation of the subsurface formations.

In addition, except for the above clustering, VAE may also be used for regression, to map an input to another output, such as using resistivity, acoustic P velocity, and S velocity to get porosity.

The process as described above may also be used for other scenarios, including, but not limited to reservoir characterization, geomechanical interpretation, and a petrophysics and geophysics based joint interpretation as discussed above in FIG. 2.

FIG. 6 illustrates an example workflow 600 for using a generative machine learning model to perform latent space clustering, according to some aspects of the disclosed technology. By way of example, for a lithological interpretation, input X 602 may represent raw measurement data collected from subsurface rocks as discussed above with respect to FIG. 5.

The flow-based generative model as illustrated in FIG. 6 can be a type of deep learning architecture that can model complex distributions by transforming a simple base distribution (e.g., Gaussian distribution) to the target distribution using a series of invertible mappings. For example, a flow-based generative model can used to convert the input data into a flow-based generative model latent space 604 representation. The flow-based generative model latent space 604 may act as a compressed or encoded version of the input X 602 data. The clustering model 606 can categorize similar data points in the latent space 604 into clusters and output Y 608 of the workflow 600 can be the result of the clustering model.

In some aspects, since a flow-based generative model is a strict revertible, that means the input and output are same from theory, and it may not be used in regression.

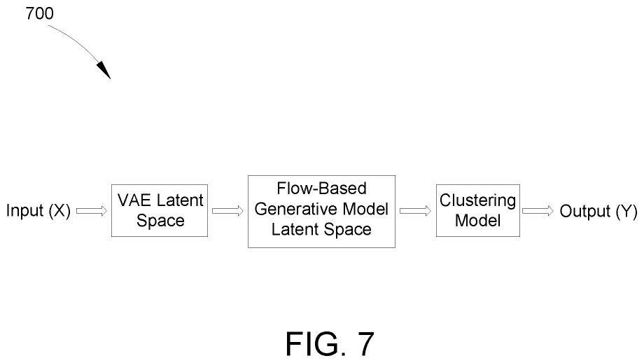

FIG. 7 illustrates a workflow 700 to perform latent space clustering using a VAE and a generative machine learning model, according to some aspects of the disclosed technology.

There may exist some vacant areas in the latent space constructed by VAE. In some instances, vacant areas can cause some uncertainty in the predicted results. The flow-based generative model can be used together with a VAE to generate the latent space and to get a full covered latent space. The clustering model can be applied to generate the output. The above example may not only include flow-based generative models, but can also include other generative models, such as a Restricted Boltzmann machine (RBM), in which the hidden layer can act as the latent space. Similar approaches can also be used for clustering or classification.

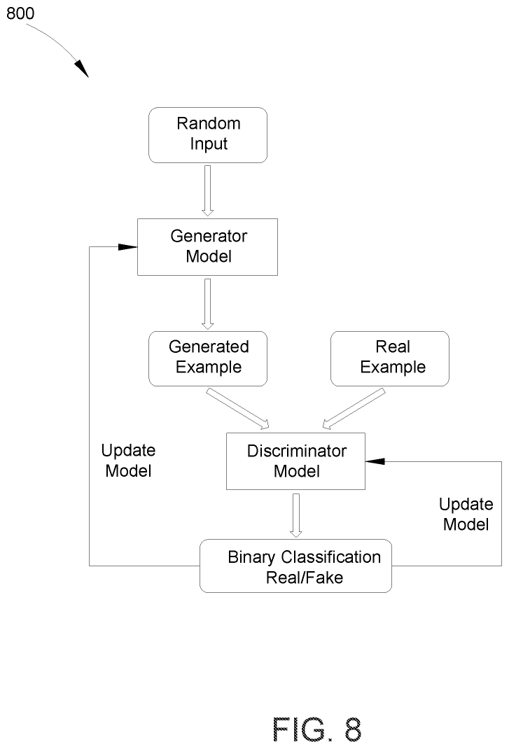

FIG. 8 illustrates an example system 800 of a generative adversarial network (GAN), according to some aspects of the disclosed technology. The GAN includes may two models, a generator and a discriminator, which can be trained together. By way of example, the generator can generate a batch of samples, and these, along with real examples from the domain, can be provided to the discriminator and classified as real or fake. The discriminator can then be updated to get better at discriminating real and fake samples in the next round, and the generator can be updated based on how well, or not, the generated samples have fooled the discriminator.

In some aspects, there are two application scenarios of a GAN. In a first scenario, when there is not sufficient input data for training, a GAN can be used to generate data samples which capture the characteristics of the input data to compensate for the lack of data samples. In a second scenario, the discriminator of a GAN can be used for classification.

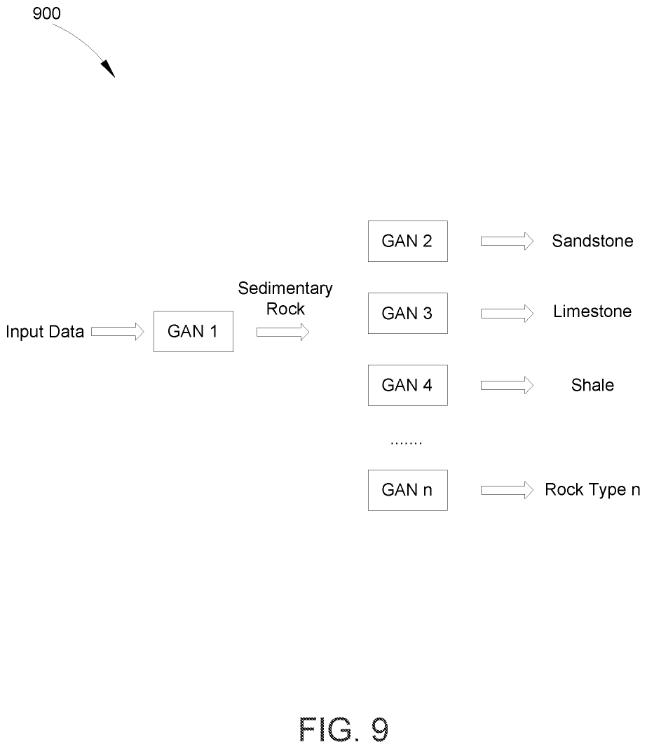

FIG. 9 illustrates a system diagram 900 utilizing GANs to perform lithographic classification, according to some aspects of the disclosed technology. The system diagram 900 as illustrated in FIG. 9 shows an example of applying a GAN for rock type classification. The different GAN models can be trained for different types of rock. In addition, each GAN may be used independently for a certain rock type identification.

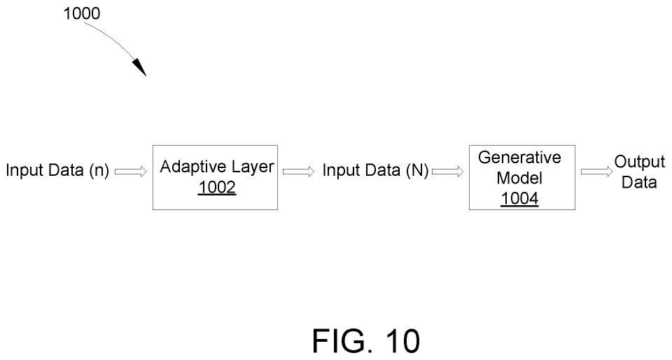

FIG. 10 illustrates an example workflow 1000 for implementing a generative model with an uncertain number of inputs, according to some aspects of the disclosed technology. In some instances, the number of inputs for a generative model 1004 can be fixed. In petrophysical interpretation, some logging data may not be available at certain depths. As a result, a different number of inputs may exist for different depths. An adaptive layer 1002 may be used before the input data is entering generative model 1004. As illustrated in FIG. 10, the complete number of inputs is N, and the number of inputs is n (n<=N). The adaptive layer 1002 can map n inputs to N inputs. For the missing inputs, default values may be filled in with adaptive layer 1002. The adaptive layer 1002 may ensure the number of inputs for generative model 1004 is a fixed number and a trained generative model 1004 does not need to be retrained due to some missing data.

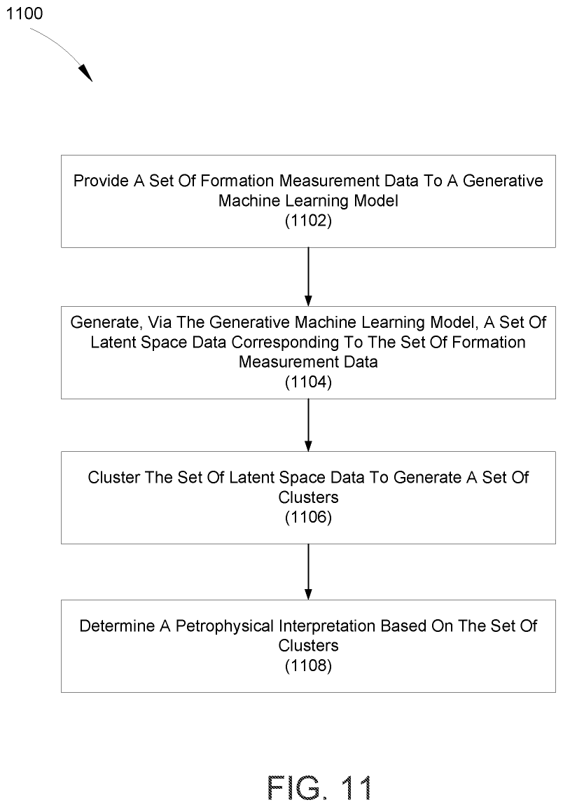

FIG. 11 illustrated an example of a process 1100 for using a generative machine learning model to output a petrophysical interpretation, according to some aspects of the disclosed technology. At step 1102, process 1100 includes providing a set of formation measurement data to a generative machine learning model. For example, formation measurement data (e.g., measurement data 202 as illustrated in FIG. 2) may include data obtained from various tools and methods used to investigate and analyze the subsurface rock formations that can help in characterizing the rock properties, fluid content, and overall structure of the subsurface formations. The formation data can include well logs, core samples, seismic data, production rates, fluid flow, pressure data, and geological information. Those skilled in the art will appreciate additional types of formation data that can be used for petrophysical interpretation.

At block 1104, process 1100 includes generating, via the generative machine learning model, a set of latent space data corresponding to the set of formation measurement data. For example, the generative machine learning model may include GANs, VAEs, FBGMs, Naive Bayes classifiers, GMMs, HMMs, and RBMs. The latent space data may be generated by the generative machine learning model (e.g., an encoder) as a representation of the set of formation measurement data.

At block 1106, process 1100 includes clustering the set of latent space data to generate a set of clusters. For example, a clustering model may generate a set of clusters by identifying and grouping closely related points in the latent space data. For example, for a lithological interpretation application with a VAE model that is effectively trained, the clustering model may cluster similar rock types together.

At block 1108, process 1100 includes determining a petrophysical interpretation based on the set of clusters. For example, in a lithological interpretation application, the petrophysical interpretation may include descriptions of different types of rocks (e.g., shale, limestone, sandstone) based on or corresponding to the set of clusters. In other words, in this example each cluster in the set of clusters may be associated with a specific rock type,

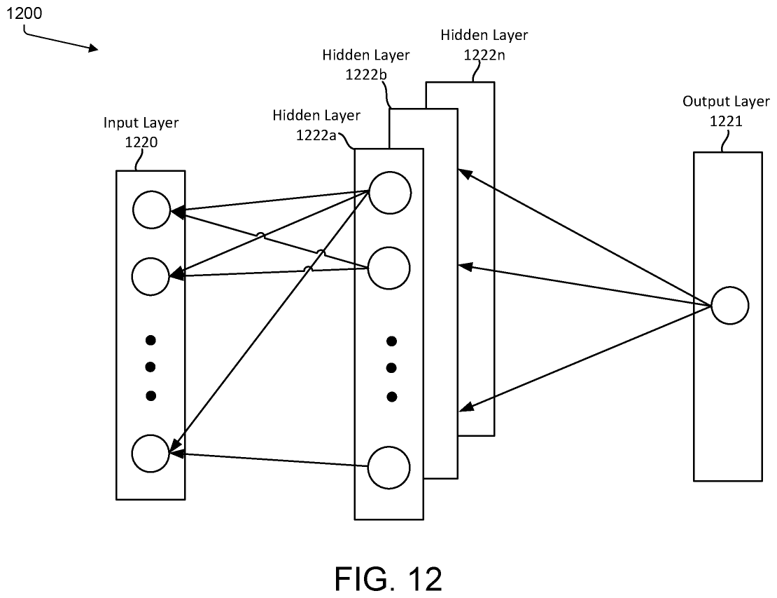

FIG. 12 is an example of a machine learning architecture (also neural network) 1200 that can be used to implement all or a portion of the systems and techniques described herein (e.g., neural network 1200 can be used to implement a symbolic regression model, as discussed above). Neural network 1200 includes multiple hidden layers 1222a, 1222b, through 1222n. The hidden layers 1222a, 1222b, through 1222n include “n” number of hidden layers, where “n” is an integer greater than or equal to one. The number of hidden layers can be made to include as many layers as needed for the given application. Neural network 1200 further includes an output layer 1221 that provides an output resulting from the processing performed by the hidden layers 1222a, 1222b, through 1222n.

The neural network 1200 is a multi-layer neural network of interconnected nodes. Each node can represent a piece of information. Information associated with the nodes is shared among the different layers and each layer retains information as information is processed. In some cases, the neural network 1200 can include a feed-forward network, in which case there are no feedback connections where outputs of the network are fed back into itself. In some cases, the neural network 1200 can include a recurrent neural network, which can have loops that allow information to be carried across nodes while reading in input.

Information can be exchanged between nodes through node-to-node interconnections between the various layers. Nodes of the input layer 1220 can activate a set of nodes in the first hidden layer 1222a. For example, as shown, each of the input nodes of the input layer 1220 is connected to each of the nodes of the first hidden layer 1222a. The nodes of the first hidden layer 1222a can transform the information of each input node by applying activation functions to the input node information. The information derived from the transformation can then be passed to and can activate the nodes of the next hidden layer 1222b, which can perform their own designated functions. Example functions include convolutional, up-sampling, data transformation, and/or any other suitable functions. The output of the hidden layer 1122b can then activate nodes of the next hidden layer, and so on. The output of the last hidden layer 1222n can activate one or more nodes of the output layer 1221, at which an output is provided. In some cases, while nodes in the neural network 1200 are shown as having multiple output lines, a node can have a single output and all lines shown as being output from a node represent the same output value.

In some cases, each node or interconnection between nodes can have a weight that is a set of parameters derived from the training of the neural network 1200. Once the neural network 1200 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 1200 to be adaptive to inputs and able to learn as more and more data is processed.

The neural network 1200 is pre-trained to process the features from the data in the input layer 1220 using the different hidden layers 1222a, 1222b, through 1222n in order to provide the output through the output layer 1221.

In some cases, the neural network 1200 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 1100 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½(target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 1200 can perform a backward pass by determining which inputs (weights) most contributed to the loss of the network, and can adjust the weights so that the loss decreases and is eventually minimized.

The neural network 1200 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for down-sampling), and fully connected layers. The neural network 1200 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

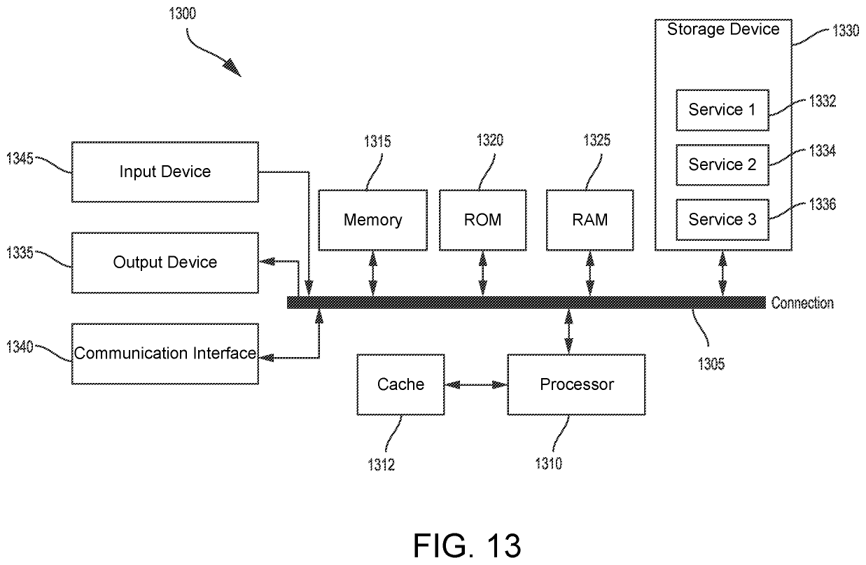

FIG. 13 illustrates an example processor-based system with which some aspects of the subject technology can be implemented. For example, processor-based system 1300 can be any computing device making up, or any component thereof in which the components of the system are in communication with each other using connection 1305. Connection 1305 can be a physical connection via a bus, or a direct connection into processor 1310, such as in a chipset architecture. Connection 1305 can also be a virtual connection, networked connection, or logical connection.

In some embodiments, computing system 1300 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1300 includes at least one processing unit (Central Processing Unit (CPU) or processor) 1310 and connection 1305 that couples various system components including system memory 1315, such as Read-Only Memory (ROM) 1320 and Random-Access Memory (RAM) 1325 to processor 1310. Computing system 1300 can include a cache of high-speed memory 1312 connected directly with, in close proximity to, or integrated as part of processor 1310.

Processor 1310 can include any general-purpose processor and a hardware service or software service, such as services 1332, 1334, and 1336 stored in storage device 1330, configured to control processor 1310 as well as a special-purpose processor where software instructions are incorporated into the actual processor design. Processor 1310 may essentially be a completely self-contained computing system, containing multiple cores or processors, a bus, memory controller, cache, etc. A multi-core processor may be symmetric or asymmetric.

To enable user interaction, computing system 1300 includes an input device 1345, which can represent any number of input mechanisms, such as a microphone for speech, a touch-sensitive screen for gesture or graphical input, keyboard, mouse, motion input, speech, etc. Computing system 1300 can also include output device 1335, which can be one or more of a number of output mechanisms known to those of skill in the art. In some instances, multimodal systems can enable a user to provide multiple types of input/output to communicate with computing system 1300. Computing system 1300 can include communications interface 1340, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 1340 may also include one or more Global Navigation Satellite System (GNSS) receivers or transceivers that are used to determine a location of the computing system 1300 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1330 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L#), Resistive RAM (RRAM/ReRAM), Phase Change Memory (PCM), Spin Transfer Torque RAM (STT-RAM), another memory chip or cartridge, and/or a combination thereof.

Storage device 1330 can include software services, servers, services, etc., that when the code that defines such software is executed by the processor 1310, it causes the system 1300 to perform a function. In some embodiments, a hardware service that performs a particular function can include the software component stored in a computer-readable medium in connection with the necessary hardware components, such as processor 1310, connection 1305, output device 1335, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### SELECTED EXAMPLES

Illustrative examples of the disclosure include:

Aspect 1. An apparatus comprising: at least one memory; and at least one processor coupled to the at least one memory, the at least one processor configured to: provide a set of formation measurement data to a generative machine learning model; generate, via the generative machine learning model, a set of latent space data corresponding to the set of formation measurement data; cluster the set of latent space data to generate a set of clusters; and determine a petrophysical interpretation based on the set of clusters.

Aspect 2. The apparatus of Aspect 1, wherein the generative machine learning model is a variational autoencoder (VAE).

Aspect 3. The apparatus of any of Aspects 1-2, wherein the generative machine learning model is a flow-based generative model (FBGM).

Aspect 4. The apparatus of any of Aspects 1-3, wherein the generative machine learning model is a generative adversarial network (GAN).

Aspect 5. The apparatus of any of Aspects 1-4, wherein the set of formation measurement data comprises at least one of well logs, core samples, seismic data, production rates, fluid flow, pressure data, geological information, or a combination thereof.

Aspect 6. The apparatus of any of Aspects 1-5, wherein the petrophysical interpretation comprises at least one of rock types, porosity, permeability, saturation, lithology, formation pressure, fluid types, or a combination thereof.

Aspect 7. The apparatus of Aspect 2, wherein the VAE comprises an encoder network, a sampled latent vector, and a decoder network.

Aspect 8. A computer-implemented method comprising: providing a set of formation measurement data to a generative machine learning model; generating, via the generative machine learning model, a set of latent space data corresponding to the set of formation measurement data; clustering the set of latent space data to generate a set of clusters; and determining a petrophysical interpretation based on the set of clusters.

Aspect 9. The computer-implemented method of Aspect 8, wherein the generative machine learning model is a variational autoencoder (VAE).

Aspect 10. The computer-implemented method of any of Aspects 8-9, wherein the generative machine learning model is a flow-based generative model (FBGM).

Aspect 11. The computer-implemented method of any of Aspects 8-10, wherein the generative machine learning model is a generative adversarial network (GAN).

Aspect 12. The computer-implemented method of any of Aspects 8-11, wherein the set of formation measurement data comprises at least one of well logs, core samples, seismic data, production rates, fluid flow, pressure data, geological information, or a combination thereof.

Aspect 13. The computer-implemented method of any of Aspects 8-12, wherein the petrophysical interpretation comprises at least one of rock types, porosity, permeability, saturation, lithology, formation pressure, fluid types, or a combination thereof.

Aspect 14. The computer-implemented method of Aspect 9, wherein the VAE comprises an encoder network, a sampled latent vector, and a decoder network.

Aspect 15. A non-transitory computer-readable storage medium comprising at least one instruction for causing a computer or processor to: provide a set of formation measurement data to a generative machine learning model; generate, via the generative machine learning model, a set of latent space data corresponding to the set of formation measurement data; cluster the set of latent space data to generate a set of clusters; and determine a petrophysical interpretation based on the set of clusters.

Aspect 16. The non-transitory computer-readable storage medium of Aspect 15, wherein the generative machine learning model is a variational autoencoder (VAE).

Aspect 17. The non-transitory computer-readable storage medium of any of Aspects 15-16, wherein the generative machine learning model is a flow-based generative model (FBGM).

Aspect 18. The non-transitory computer-readable storage medium of any of Aspects 15-17, wherein the generative machine learning model is a generative adversarial network (GAN).

Aspect 19. The non-transitory computer-readable storage medium of any of Aspects 15-18, wherein the set of formation measurement data comprises at least one of well logs, core samples, seismic data, production rates, fluid flow, pressure data, geological information, or a combination thereof.

Aspect 20. The non-transitory computer-readable storage medium of any of Aspects 15-19, wherein the petrophysical interpretation comprises at least one of rock types, porosity, permeability, saturation, lithology, formation pressure, fluid types, or a combination thereof.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. An apparatus comprising:
at least one memory; and
at least one processor coupled to the at least one memory, the at least one processor configured to:
provide a set of formation measurement data to a generative machine learning model;
generate, via the generative machine learning model, a set of latent space data corresponding to the set of formation measurement data;
cluster the set of latent space data to generate a set of clusters; and
determine a petrophysical interpretation based on the set of clusters.

2. The apparatus of claim 1, wherein the generative machine learning model is a variational autoencoder (VAE).

3. The apparatus of claim 1, wherein the generative machine learning model is a flow-based generative model (FBGM).

4. The apparatus of claim 1, wherein the generative machine learning model is a generative adversarial network (GAN).

5. The apparatus of claim 1, wherein the set of formation measurement data comprises at least one of well logs, core samples, seismic data, production rates, fluid flow, pressure data, geological information, or a combination thereof.

6. The apparatus of claim 1, wherein the petrophysical interpretation comprises at least one of rock types, porosity, permeability, saturation, lithology, formation pressure, fluid types, or a combination thereof.

7. The apparatus of claim 2, wherein the VAE comprises an encoder network, a sampled latent vector, and a decoder network.

8. A computer-implemented method comprising:
providing a set of formation measurement data to a generative machine learning model;
generating, via the generative machine learning model, a set of latent space data corresponding to the set of formation measurement data;
clustering the set of latent space data to generate a set of clusters; and
determining a petrophysical interpretation based on the set of clusters.

9. The computer-implemented method of claim 8, wherein the generative machine learning model is a variational autoencoder (VAE).

10. The computer-implemented method of claim 8, wherein the generative machine learning model is a flow-based generative model (FBGM).

11. The computer-implemented method of claim 8, wherein the generative machine learning model is a generative adversarial network (GAN).

12. The computer-implemented method of claim 8, wherein the set of formation measurement data comprises at least one of well logs, core samples, seismic data, production rates, fluid flow, pressure data, geological information, or a combination thereof.

13. The computer-implemented method of claim 8, wherein the petrophysical interpretation comprises at least one of rock types, porosity, permeability, saturation, lithology, formation pressure, fluid types, or a combination thereof.

14. The computer-implemented method of claim 9, wherein the VAE comprises an encoder network, a sampled latent vector, and a decoder network.

15. A non-transitory computer-readable storage medium comprising at least one instruction for causing a computer or processor to:
provide a set of formation measurement data to a generative machine learning model;
generate, via the generative machine learning model, a set of latent space data corresponding to the set of formation measurement data;
cluster the set of latent space data to generate a set of clusters; and
determine a petrophysical interpretation based on the set of clusters.

16. The non-transitory computer-readable storage medium of claim 15, wherein the generative machine learning model is a variational autoencoder (VAE).

17. The non-transitory computer-readable storage medium of claim 15, wherein the generative machine learning model is a flow-based generative model (FBGM).

18. The non-transitory computer-readable storage medium of claim 15, wherein the generative machine learning model is a generative adversarial network (GAN).

19. The non-transitory computer-readable storage medium of claim 15, wherein the set of formation measurement data comprises at least one of well logs, core samples, seismic data, production rates, fluid flow, pressure data, geological information, or a combination thereof.

20. The non-transitory computer-readable storage medium of claim 15, wherein the petrophysical interpretation comprises at least one of rock types, porosity, permeability, saturation, lithology, formation pressure, fluid types, or a combination thereof.
